(19) United States
(12) Patent Application Publication
(10) Pub. No.: US 2011/0132538 A1
(43) Pub. Date: Jun. 9, 2011

(54) LABEL

(76) Inventors: Robert Graham Bonney, Beckley (GB); James Alan Clementson, Rothwell (GB); Ian Elliott, Boulogne-Billancourt (FR)

(21) Appl. No.: 12/942,335

(22) Filed: Nov. 9, 2010

Related U.S. Application Data
(63) Continuation of application No. PCT/GB2008/002833, filed on Aug. 22, 2008.

(30) Foreign Application Priority Data
May 9, 2008 (GB) 0808445.1

(51) Int. Cl. B32B 3/10; C08F 2/48; B32B 37/22; B41J 2/01

(52) U.S. Cl. 156/299; 427/511; 428/196; 347/102

(57) ABSTRACT

A method of producing a heat sealable label comprises the steps of:

(i) providing a textile substrate which is of synthetic polymeric fibres and which is provided on one of its faces with a heat sealable adhesive,

(ii) applying to the other face of the substrate a curable resin system,

(iii) effecting cross-linking of said curable resin system,

(iv) printing on to said cross-linked resin system a uv curable ink in the form of the desired marking, and

(v) effecting uv curing of said ink.

The ink incorporates monomer components which during the uv curing of step (iv) covalently bond to the cross-linked resin system.

### CROSS REFERENCE TO RELATED APPLICATIONS

This application is a continuation of PCT/GB2008/002833 filed Aug. 22, 2008, which claims the benefit of British Patent Application No. 0808445.1 filed May 9, 2008.

The present invention relates to a heat sealable label which has a marking (e.g. informative and/or decorative) thereon and which is intended to be attached to a garment or other article to be marked by the application of heat and pressure. The invention relates more particularly, but not necessarily exclusively, to labels that as attached to a garment are likely to be subjected to repeated heavy duty, e.g. industrial, laundering operations and that are capable of withstanding such laundering without loss of the marking.

Heat sealable labels are used extensively for providing markings on garments, e.g. work wear. Such labels generally comprise a textile substrate provided on one surface with a heat sealable adhesive (for bonding the label to the garment) and having a detectable (usually visible) marking on its other surface. Such markings may be applied to the textile substrate in various ways, e.g. by embroidery, silk screen printing or sublimination transfer printing.

Embroidery is a slow high cost process and if applied direct to the garment is a permanent marking which cannot be practically removed. Sublimation is a rapid and inexpensive method of decoration but it suffers from fading when subjected to repeated washing and drying. Silk screen is a mid cost process which produces a permanent badge but which requires a large amount of pre production work and set up. This means that silk screen is suited to longer run production and is often not cost effective for small numbers of rapidly produced badges.

It is therefore an object of the invention to obviate or mitigate the abovementioned disadvantages.

According to a first aspect of the present invention there is provided a method of producing a heat sealable label comprising the steps of:

(i) providing a textile substrate which is of synthetic polymeric fibres and which is provided on one of its faces with a heat sealable adhesive,

(ii) applying to the other face of the substrate a curable resin system,

(iii) effecting cross-linking of said curable resin system,

(iv) printing on to said cross-linked resin system a uv curable ink in the form of the desired marking, and

(v) effecting uv curing of said ink,

said ink incorporating monomer components which during the uv curing of step (iv) covalently bond to the cross-linked resin system.

According to a second aspect of the present invention there is provided a heat sealable label comprising:

(a) a textile substrate which is of synthetic polymeric fibres;

(b) a heat sealable adhesive provided on one face of the textile substrate;

(c) a cross-linked resin system provided on the other face of the textile substrate; and

(d) a marking of a uv cured ink covalently bonded to the cross-linked resin system.

The invention further provides a method of providing an article (e.g. a textile article such as a garment) with a marking, the method comprising applying to said article by means of heat and pressure a label produced in accordance with the method of the first aspect of the invention or a label defined for the second aspect of the invention.

The colour in the UV ink is produced by separate pigments which are, as you state, entrapped by the monomers as they cure to the final polymer. It is the polymer vehicle that bonds to the cross-linked resin.

Thus the invention is based on the concept that the uv cured ink (that provides the decorative and/or informative marking) is convalently bonded to the cross-linked resin system previously formed on the textile substrate. We have found that labels produced in accordance with the invention provide markings that are very durable and able to withstand repeated heavy duty laundering of a garment to which the label is applied. The labels are therefore eminently suitable for application to work wear which is likely to be subject to repeated industrial laundering. Without wishing to be bound by theory, we believe that the durability is due to pigments in the ink being entrapped by the monomers in the ink as they cure to the final polymer which in turn becomes bonded to the cross-linked resin.

In one preferred embodiment of the invention, the textile substrate has a resin coating to which the curable resin (ii) is applied. This resin coating serves to protect the textile fabric during washing and may be one to which the resin (ii) becomes covalently bonded during curing. The resin coating provides a “link” between the textile substrate and the cured resin formed in step (iii) of the process and may be one to which the cured resin becomes covalently bonded for enhanced durability. This resin coating may for example be of a polyurethane.

In an alternative embodiment of the invention, the cross-linked resin system that is formed in step (iii) of the process is one which itself become covalently bonded to the textile substrate. In this case therefore the cross-linked resin system effectively covalently links the uv cured ink to the textile substrate, thus enhancing durability of the marking on the label.

The cross-linked resin system preferably comprises a polyurethane.

The curable resin system may be applied to the textile substrate (in step (ii) of the process) in the form of a solution, suspension or dispersion of the cross-linkable components in an appropriate liquid carrier (usually an organic solvent).

Most conveniently, the step (ii) of the process is effected by screen printing, (onto that face of the textile substrate opposite to the adhesive) an ink (the “screen printing ink”) incorporating monomer components which in step (iii) of the process lead to the cured resin system. As indicated above, this is preferably a polyurethane and as such the screen printing ink may incorporate urethane monomers (e.g. di- or higher functionality amines) and a di- or higher-functionality isocyanate. The isocyanate is preferably aliphatic and may for example be hexamethylene diisocyanate.

The screen printing ink may for example comprise 25-30% by weight of the methane monomers and 2-5% by weight of the isocyanate together with solvents, pigments and ancillary components (e.g. a flex-additive as appropriate), preferably such that the solids content of the ink is about 50%.

Curing of the screen printing ink as applied to the substrate may then be effected. This curing process may be initiated by heat and continued at ambient temperature. For example, the screen printing ink may be cured by heat using a temperature of around 85° C. for up to 2 minutes to initiate the process which may then continue for up to 48 hrs after the heat has been applied. The sheets are however ready to use after the application of heat has dried them sufficiently to handle the sheets.

Once the screen-printing ink has been cured, the uv curable ink may be applied.

The uv curable ink may, as conventional for such inks, be comprised of 100% solids and therefore be solvent free. The uv curable ink may be an acrylate based system for which curing is initiated by free radicals generated (from a suitable photo-initiator) during the uv curing step (v).

Preferably the uv curable ink is applied to the substrate (on which the cross-linked resin system has previously been formed) by means of an ink jet printer e.g. operated under computer control). In this case, uv curing (step (v)) may be effected by a uv lamp on the ink jet printing head passing over the substrate immediately after the ink jet. This cures the ink in thin strips as it is printed so that the ink does not have chance to spread and blur the image.

The uv curing step will usually be accompanied by the generation of heat which can cause the textile substrate to “curl” which may have a detrimental effect on the ink jet printing operation that is effected immediately upstream of the uv curing. Steps that may be taken to prevent such curling are detailed more fully below.

The textile substrate is of synthetic fibres (and is preferably comprised of 100% of such fibres) since we have found that, with such fibres, steps (ii) and (iii) lead to a smooth surface of cross-linked resin which is advantageous for ensuring that the image, which is produced by a series of fine dots, does not have any interference or moiré patterns in it. In contrast natural fibres have been found to be too absorbent and do not lead to a smooth cross-linked resin surface.

Preferably the synthetic fibres of the substrate are polyester which ensure that the label remains flexible when applied by means of heat and pressure to a garment to be marked. In contrast, the use of a textile substrate comprised of polyamide fibres may tend to produce a label which (when applied by heat and pressure to a garment) may be of reduced flexibility, which can be a disadvantage in certain situations.

For preference the textile substrate is a woven material, most preferably a finely woven material since the “fineness of the weave will help contribute to a smooth surface for the cross-linked resin. Preferably also the woven textile substrate has flat warp and flat weft threads. Particularly suitable textile substrates have a basis weight of 90 to 110 g m⁻² with a 78 DTX flat warp and a 110 DTX flat weft. The fabric will preferably have 76 picks per inch and 120 ends per inch.

The adhesive that is applied to the textile substrate (for the purpose of bonding the label to a garment) is most preferably a thermoplastic adhesive, e.g. a thermoplastic polyurethane having a melting point of about 170° C. Application of the adhesive may be by lamination or hot melt spread coating.

Once the adhesive has been applied to the textile substrate it is preferred that the adhesive coated substrate is treated (prior to application of the curable resin in step (ii)) to reduce curl of the textile substrate caused by the generation of heat in step (iv) in which the uv curable ink is cured by uv light. If it substains curls of this stage then a number of problems may be encountered. These include:

(a) a reduction in label quality due to problems with the ink jet printing onto a surface that is curling;

(b) the label can retain this curl when cut out; and

(c) the curl can also make the label difficult to apply when positioned under a heat press for application.

The thermoplastic adhesive will generally be applied in a heated condition to the textile substrate. In this case the treatment to inhibit curl may be effected by initially allowing the adhesive to cool then reheating and embossing with a pattern to “break-up” the adhesive. This pattern may for example be a random cross hatched random pattern which does not allow the adhesive to line up in any direction and therefore give curl in that direction.

The invention will now be illustrated by the following non-limiting Example which describes production of one construction of label in accordance with the invention.

### EXAMPLE 1 (Invention)

A label was produced using a roll of fabric having the following specification:

Colour:=White

Base Fabric Substrate=Polyester

Coating:=Polyurethane Base

Construction:=77% Base Material =23% Coating

Weight:=94 g/m²±5%

Coating Weight:=22 g/m²±5%

Substrate Weight=72 g/m²±5%

Picks per inch=76 DTX flat warp

Ends per inch=120 DTX flat weft

Warp=78 DTX flat

Weft=110 DTX flat

An adhesive coating of a clear Estane polyurethane resin was applied to one side of the polyester substrate web by hot melt spread coating to a level of 130 gsm (±10 gsm). The Estane was then annealed by heating and an Eton emboss finish applied to give the substrate “anti-curl” characteristics.

Individual sheets were then cut from the web for 720 mm×520 mm screen print beds and the following ink formation was then applied as a coating to the face of the substrate using a 55 T mesh screen:

41.6% Cyclohexanone

26.5% urethane monomers

17.7% titanium dioxide (pigment)

6.2% solvent naphtha

3.5% hexamethylene diisocyanate

2.7% ethanol, 2-(1-methylethoxy)-acetate

1.8% 2-isopropoxyethanol

The sheets produced were passed through a drying tunnel at a temperature of 85° C. for two minutes and then placed in a drying rack over night, thereby resulting in curing of the screen-applied resin formulation.

A plurality of designs were then applied to the faces of the “non-adhesive” faces of the sheets using a UV inkjet printer system. The UV ink used was one supplied by Fujifilm Sericol ((composition: oxybis (methyl-2, 1-ethanediyl) diacrylate, phosphine oxide, diphenyl 1 (2,4,6-tri-methylbenzoyl)).

Individual labels were then cut from the sheet using a laser cutter.

### EXAMPLE 2 (Invention)

The procedure of Example 1 was followed save for a modification of the procedure by which the adhesive was applied.

In the present Example, a tie-coat (7-10 gsm) of a clear polyurethane was applied to one face of the polyester substrate and a 25 micron polyurethane film (providing the adhesive layer) was applied to that face using a lamination temperature of 160-190° C.

### EXAMPLE 3 (Comparative)

For the purposes of comparison, labels were produced following the procedure described in Example 1 but omitting the step of applying the resin coating by screen printing.

### EXAMPLE 4 (Testing)

Four labels produced in accordance with each of Examples 1, 2 and 3 were applied using heat and pressure to a black fabric.

The fabrics (with applied labels) were then subjected to 25 cycles of bleach washing followed by tumble drying.

It was found that the Comparative Labels produced in accordance with Example 3 “greyed” and exhibited a loss of sheen after the first cycle. In contrast, the labels of the invention produced in accordance with Examples 1 and 2 did not exhibit any damage after this first cycle.

No further change was detected for any of the labels during the subsequent 24 cycles.

This testing procedure demonstrates the effectiveness of the application (and curing) of the screen-applied resin coating to the durability of the final label.

1. A method of producing a heat sealable label comprising the steps of:
(i) providing a textile substrate which is of synthetic polymeric fibres and which is provided on one of its faces with a heat sealable adhesive,
(ii) applying to the other face of the substrate a curable resin system,
(iii) effecting cross-linking of said curable resin system,
(iv) printing on to said cross-linked resin system a uv curable ink in the form of the desired marking, and
(v) effecting uv curing of said ink,
said ink incorporating monomer components which during the uv curing of step (iv) covalently bond to the cross-linked resin system.

2. A method as claimed in claim 1 wherein the textile substrate is provided with a resin coating to which the curable resin system is applied in step (ii) of the method.

3. A method as claimed in claim 2 wherein the resin coating comprises a polyurethane.

4. A method as claimed in claim 2 wherein in step (iii) of the method said curable resin system becomes covalently bonded to the resin coating.

5. A method as claimed in claim 1 wherein the curable resin system forms, in step (iii), a cross-linked resin system that is covalently bonded to the textile substrate.

6. A method as claimed in claim 1 wherein the cross-linked resin system comprises a polyurethane.

7. A method as claimed in claim 1 wherein, in step (ii), the curable resin system is applied to the textile substrate in the form of a solution, dispersion or suspension of the cross-linkable components in a liquid carrier.

8. A method as claimed in claim 7 wherein step (ii) of the process is effected by screen printing.

9. A method as claimed in claim 1 wherein the uv curable ink is comprised of 100% solids.

10. A method as claimed in claim 1 wherein the uv curable ink is an acrylate based system incorporating a photo-initiator capable of generating free radicals.

11. A method as claimed in claim 1 wherein the uv curable ink is applied to the substrate by means of an ink jet printer.

12. A method as claimed in claim 11 wherein step (v) is effected by a uv lamp on the ink jet printing head.

13. A method as claimed in claim 1 wherein the textile substrate is a woven polyester fabric.

14. A heat sealable label produced by the method of claim 1.

15. A heat sealable label comprising:
(a) a textile substrate which is of synthetic polymeric fibres;
(b) a heat sealable adhesive provided on one face of the textile substrate;
(c) a cross-linked resin system provided on the other face of the textile substrate; and
(d) a marking of a uv cured ink covalently bonded to the cross-linked resin system.

16. A label as claimed in claim 15 wherein the textile substrate comprises a woven polyester fabric.

17. A label as claimed in claim 15 wherein the textile substrate includes a resin coating on which said cross-linked resin system is provided.

18. A label as claimed in claim 16 wherein said cross-linked resin system is covalently bonded to said coating.

19. A label as claimed in claim 15 wherein the cross-linked resin system is covalently bonded to the textile substrate.

20. A label as claimed in claim 15 wherein the cross-linked resin system comprising a polyurethane.

21. A method of providing an article with a marking comprising applying to said article a label as claimed in claim 15, said application being by means of heat and pressure.

22. A method as claimed in claim 21 wherein the article is of a textile material.

23. A method as claimed in claim 22 wherein the article is a garment.
